(19) United States
(12) Patent Application Publication
(10) Pub. No.: US 2014/0344083 A1
(43) Pub. Date: Nov. 20, 2014

(54) PORTABLE MOBILE MONEY DEVICE

(71) Applicant: EQUATEL (UK) LTD, Newcastle (GB)

(72) Inventor: Eli Rosenes, Beit-Shemesh (IL)

(21) Appl. No.: 14/370,490

(22) PCT Filed: Jan. 2, 2013
(86) PCT No.: PCT/IB2013/050024

§ 371 Date: Jul. 3, 2014

Related U.S. Application Data
(60) Provisional application No. 61/582,530, filed on Jan. 3, 2012.

(51) Int. Cl. G06Q 20/34; G06Q 20/20

(52) U.S. Cl. CPC G06Q 20/353; G06Q 20/354; G06Q 20/209
USPC 705/17; 705/41

(57) ABSTRACT

A mobile money system comprising: at least one mobile money device configured with at least a CPU, a GSM engine, antenna, display, keypad/touchpad, printer and SIM reader; and at least one external SIM card configured to be read by the reader; wherein the mobile money device uses a SIM Tool Kit application stored on the external SIM card to process at least one mobile money transaction. A method for managing Mobile Money transactions comprising: providing a mobile money device having at least a CPU, a GSM engine, antenna, display, keypad/touchpad, printer and SIM reader configured to accept insertion of an external SIM cards; inserting an end-user external SIM card into the SIM reader; reading the end-user external SIM card; validating the end-user external SIM card has a SIM Tool Kit application; registering the end-user external SIM card on a network; using the network connection to transmit data to and from the mobile money device; displaying a SIM Tool Kit application menu on the display; choosing at least one option from the menu using the keypad/touchpad; inserting data if required; sending data regarding the chosen menu option via the network connection; receiving a response regarding the data via the network; displaying the response on the display; and printing a transaction receipt.

### FIELD AND BACKGROUND OF THE INVENTION

The present invention relates to Mobile Money Systems and, in particular, it concerns a Mobile Money Systems having a portable Mobile Money Device for use with multiple interchangeable external SIM (Subscriber Identity Module) cards and a method for managing Mobile Money transactions.

Automated Teller Machines (ATM) are well known. Such devices provide an opportunity for customers to perform a variety of banking tasks remote from the banking institution. Generally, however, ATM's are used as a cash withdrawal device that is never closed.

WO2009/018682 by Kamfu Wong suggests a cashless ATM in which that ATM allows transactions by communicating remotely with banks so as to transfer funds between different bank accounts. Such a system provides time of transaction transfer of funds for purchases and/or cash advances.

In all ATM systems currently known, the user's card, be it a smart card or a magnetic strip card, is used solely to identify and authenticate the user. The operational application is loaded into the ATM device.

There is, therefore, a need for a Mobile Money System having a portable Mobile Money Device for use with multiple interchangeable external SIM cards in which the operational application is loaded onto the external SIM card and the Mobile Money Device is configured to run a variety of operational applications.

### SUMMARY OF THE INVENTION

The present invention is a Mobile Money System having a portable Mobile Money Device for use with multiple interchangeable external SIM cards in which the operational application is loaded onto the external SIM card and the Mobile Money Device is configured to run a variety of operational applications.

According to the teachings of the present invention there is provided, a mobile money system comprising: (a) at least one mobile money device configured with at least a CPU, a GSM engine, antenna, display, keypad/touchpad, printer and SIM reader; and (b) at least one external SIM card configured to be read by the SIM reader; wherein the SIM reader is configured to accept insertion and removal of the external SIM card while said mobile money device is in an operational state and the mobile money device uses a SIM Tool Kit application stored on the external SIM card to process at least one mobile money transaction.

According to a further teaching of the present invention, the external SIM card is used to establish a network data communication connection.

According to a further teaching of the present invention, the SIM Tool Kit is altered by a service provider from whom an end-user received the external SIM card.

According to a further teaching of the present invention, the alteration is made via the network data communication connection.

According to a further teaching of the present invention, the printer is configured to print a transaction receipt for the mobile money transaction.

According to a further teaching of the present invention, a memory cache is created at the beginning of the mobile money transaction, each step of the mobile money transaction is recorded in the memory cache and any retracted step is deleted from the memory cache, such that the steps still in the memory cache are printed as the transaction receipt.

According to a further teaching of the present invention, the at least one mobile money device is configured as a plurality of mobile money devices and the at least one external SIM card is configured as a plurality of external SIM cards.

There is also provided according to the teachings of the present invention, a portable mobile money device comprising: at least a CPU, a GSM engine, antenna, display, keypad/touchpad, printer and SIM reader configured to accept and recognize insertion and removal of an external SIM card while said mobile money device is in an operational state; wherein the CPU is configured to operate at least one SIM Tool Kit application stored on the external SIM card so as to process at least one mobile money transaction when the external SIM card is inserted into the SIM reader.

According to a further teaching of the present invention, the external SIM card is used to establish a network data communication connection.

According to a further teaching of the present invention, the printer is configured to print a transaction receipt for the mobile money transaction.

There is also provided according to the teachings of the present invention, a method for managing Mobile Money transactions comprising: (a) providing a mobile money device having at least a CPU, a GSM engine, antenna, display, keypad/touchpad, printer and SIM reader configured to accept insertion of an external SIM card; (b) inserting an external SIM card into the SIM reader; (c) reading the external SIM card; (d) validating the external SIM card has a SIM Tool Kit application; (e) registering the external SIM card on a network; (f) using the network connection to transmit data to and from the mobile money device; (g) displaying a SIM Tool Kit application menu on the display; (h) creating a transaction specific memory cache; (i) choosing at least one option from the menu using the keypad/touchpad and recording the choice in the transaction specific memory cache; (j) allowing the user to insert data via the keypad or touchpad if requested by the STK and recording the data in the transaction specific memory cache; (k) sending data regarding the chosen menu option via the network connection; (l) receiving a response regarding the data via the network; (m) displaying the response on the display and recording the response in the transaction specific memory cache; and (n) printing a transaction receipt based on data stored in the transaction specific memory cache.

According to a further teaching of the present invention, the sending data to the network is accomplished using the GSM engine via one of USSD, SMS and mobile data.

According to a further teaching of the present invention, the printing a transaction receipt includes displaying receipt printing options that include at least the following options: (a) client only; (b) operator only; and (c) client and operator.

According to a further teaching of the present invention, the transaction receipt includes all data of steps in the SIM Tool Kit menu that were performed during the mobile money transaction.

According to a further teaching of the present invention, the SIM Tool Kit application menu options include at least one of crediting a mobile money account and deducting from a mobile money account.

### BRIEF DESCRIPTION OF THE DRAWINGS

The invention is herein described, by way of example only, with reference to the accompanying drawings, wherein:

FIG. 1 is a block diagram of a portable Mobile Money Device for use with multiple interchangeable SIM cards according to the present invention.

### DESCRIPTION OF THE PREFERRED EMBODIMENTS

The present invention is a Mobile Money System having a portable Mobile Money Device (MMD) for use with multiple interchangeable SIM cards in which the operational application is loaded onto the SIM card and the. Mobile Money Device is configured to run a variety of operational applications.

The principles and operation of a Mobile Money System according to the present invention may be better understood with reference to the drawings and the accompanying description.

The Mobile Money System includes a portable MMD (Mobile Money Device) and is part of the Equatel “fixed wireless” solution for extending telephony to remote communities and outlying areas.

The MMD allows MM (Mobile Money) agents to serve subscribers a full range of Mobile Money transaction services including, but not limited to, depositing and withdrawing cash from their accounts and transferring funds between accounts. The device has been designed to cater to, but should not be limited to, all end users in possession of an end-user SIM card, but without access to a Mobile device, such as a cellular telephone, on which to manage transactions.

It should be noted that the external SIM card is provided by a service provider such as, but not limited to, a cellular telephone network operator, a banking institution, educational institution, government agency and non-government agency. However, the Mobile Money System of the present invention does require a network connection between the MMD and the institution in which the transaction is being carried out. Such network connection may be hardwired or wireless.

It should be understood that the end-user external SIM card may be configured as a dedicated card solely for transactions via the MMD. Alternatively, the external SIM card is configured for multipurpose use such as for use with a cellular telephone and therefore, the external SIM card may contain an array of information and operational applications such as, but not limited to, phonebook, contacts, internet information such as favorites, Web surfing history, as well as the necessary Mobile Money operational STK (SIM Tool. Kit) application and banking information. It should be noted that the STK application can be changed, updated, deleted and/or replaced remotely by the service provider via the network connection when the external SIM card is inserted into a compatible SIM reader. It should also be understood that not all external SIM cards will have the same STK application installed. That is to say, the STK application installed on a particular external SIM card is determined by the service provider based on the services to be used by the end-user and or provided by the service provider and may vary from one service provider to another. The STK application installed on a particular external SIM card may vary from one SIM card to another within the same service provider. Therefore, it will be understood that the MMD of the present invention is configured so as to provide a user interface for all such STK applications. While it is preferred that the external SIM card be configured as a type “full size”—ID-1, this is not necessary and should not be considered as a limitation. Rather, substantially any SIM card could be mounted on an adapter and used with the MMD.

Therefore, it will be appreciated that the type of SIM card is not considered the innovation of the present invention.

In its simplest form, the Mobile Money System of the present invention includes at least one MMD and at least one external SIM card. Ideally, however, the Mobile Money System of the present invention would include a plurality of MMD's and a plurality of external SIM cards.

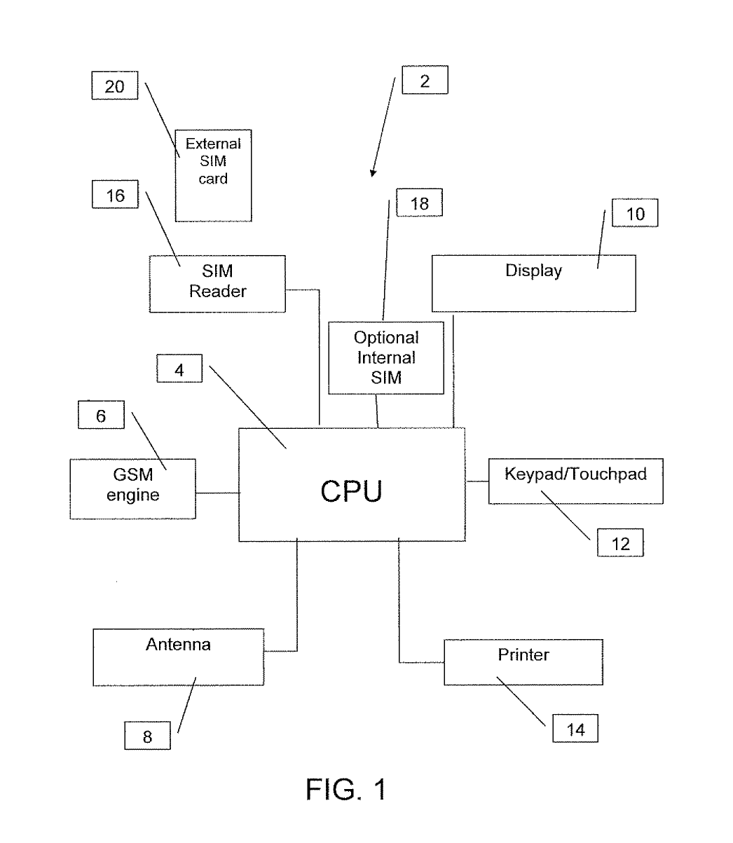

As illustrated in FIG. 1, the MMD 2 includes a CPU 4, a GSM engine 6, antenna 8, display 10, keypad/touchpad 12, printer 14 and SIM reader 16. It will be appreciated that the insertion slot of the SIM reader is open to the outside of the MMD housing and is configured to accept insertion of the external SIM cards 20, one at time, easily through the opening. In such a configuration, the MMD is configured so as to detect insertion and withdrawal of the external SIM card 20 while in an operational state (turned “on”).

Additionally or alternatively, the MMD may be configured with an internal SIM 18. In such a configuration, the MMD is configured so as to detect insertion and withdrawal of the external SIM card 20 while in an operational state (turned “on”). In such a configuration, the MMD is preferably, but not necessarily, programmed to consider the internal SIM 18 as the secondary SIM and an external SIM 20, when inserted into the SIM reader 16, as the primary SIM. Therefore, when an external SIM is inserted into the SIM reader, the MMD will detect the presence of the external SIM then mount and register it on the CPU. This may, or may not, include unregistering the internal SIM from the CPU. It will be appreciated that when the MM transaction is completed the external SIM card may optionally be unregistered from the CPU. It will be readily understood that removal of the external SIM will result in it being unregistered from the CPU, either prior to or after removal. This may, or may not, include re-registering the internal SIM on the CPU.

The software programmed into the CPU provides a user interface for the STK application programmed onto the external SIM card when inserted into the SIM reader. The Printer also provides a printing option so as to supply the end-user, the MM agent or both with a written record of a transaction performed on the MMD.

It should be understood that the optional internal SIM, when installed, may be used as the means by which the MMD connects to the network during MM transaction, rather than the end-user's external SIM card. Alternatively, the optional internal SIM may be used for purposes of updating the MMD operational software.

The MMD is a tool carried by MM agents to give access to Mobile Money services where a banking institution does not wish to install an ATM machine such as, but not limited to, schools, jails, army basis or any underserved areas. It will be readily understood that the MMD of the present invention can cater the retail market as well.

A non-limiting example of a method for use of the MMD within the framework of the Mobile Money System of the present invention may include the following steps:

1. MM Agent inserts an end-user external SIM into the MMD.

2. The MMD reads the external SIM, validates the external SIM has an STK menu and registers the external SIM on the network and uses that external SIM network connection to transmit data to and from the MMD.

3. The MMD displays the STK menu on the display.

4. Agent can choose one of the menu options by pressing the option number or scrolling with the arrow to the option, agent will then press OK.—Options may be, but are not limited to, crediting the external SIM MM account, deducting money from the external SIM MM account, etc. The end-user may be required to insert data such as, but not limited to, numbers, codes and. PINS. This is done via the keypad/touchpad.

5. When the STK applet receives and validates the inserted info, it sends the data using the GSM engine via USSD/SMS/mobile data to the network.

6. When the network sends a response for the end-user, the MMD displays it on the screen.

7. When the transaction is completed, the MMD displays the receipt printing options with the following options:
1. Client Only;
2. Operator Only;
3. Client and Operator.

When selecting an option, a receipt is printed. The receipt prints all the data of steps in the STK menu that the agent selected and were thereafter performed. If during the transaction process, the agent backs up so as to retract a step in the menu, the retracted step will not be performed or printed. Data containing codes will also not be printed. This printing process is accomplished by use of a transaction specific memory cache that is created at the beginning of each MM transaction. Each step of the transaction is recorded in the cache and any retracted step is deleted from the cache. When the option to print a receipt is selected, the steps still in the cache are printed. It will be appreciated that the cache may be emptied after each transaction or periodically, either automatically or manually.

The option to print the transaction receipt is provided because the purpose of the required data of each transaction is unknown to the MMD and may change with each STK application.

As mentioned above the MMD can also be used as a retail device, for instance, in a store where the shopper pays via MM, the cashier will insert the shopper's external SIM card into the store's MMD and transfer the appropriate sum to the store's bank account.

Alternately, the shopper may carry his/her own MMD and can pay for products by inserting their own external SIM card and transferring the appropriate sum himself to the store's bank account.

Another use of a retail device can be a store where the shopper pays via MM from his personal handset such as, but not limited to a cellular telephone, the cashier will have an MMD device that will receive the transfer, print a receipt and approve the purchase.

It will be appreciated that the above descriptions are intended only to serve as examples and that many other embodiments are possible within the spirit and the scope of the present invention.

What is claimed is:

1. A mobile money system comprising:
(a) at least one mobile money device configured with at least a CPU, a GSM engine, antenna, display, keypad/touchpad, printer and SIM reader; and
(b) at least one external SIM card configured to be read by said SIM reader;
wherein said SIM reader is configured to accept insertion and removal of said external SIM card while said mobile money device is in an operational state and said mobile money device uses a SIM Tool Kit application stored on said external SIM card to process at least one mobile money transaction.

2. The mobile money system of claim 1, wherein said external SIM card is used to establish a network data communication connection.

3. The mobile money system of claim 2, wherein said SIM Tool Kit is altered by a service provider from whom an end-user received said external SIM card.

4. The mobile money system of claim 3, wherein said alteration is made via said network data communication connection.

5. The mobile money system of claim 1, wherein said printer is configure to print a transaction receipt for said mobile money transaction.

6. The mobile money system of claim 5, wherein a memory cache is created at the beginning of said mobile money transaction, each step of the mobile money transaction is recorded in said memory cache and any retracted step is deleted from said memory cache, such that the steps still in said memory cache are printed as said transaction receipt.

7. The mobile money system of claim 1, wherein said at least one mobile money device is configured as a plurality of mobile money devices and said at least one external SIM card is configured as a plurality of external SIM cards.

8. A portable mobile money device comprising: at least a CPU, a GSM engine, antenna, display, keypad/touchpad, printer and SIM reader configured to accept insertion and removal of an external SIM card while said mobile money device is in an operational state; wherein said CPU is configured to operate at least one SIM Tool Kit application stored on said external SIM card so as to process at least one mobile money transaction when said external SIM card is inserted into said SIM reader.

9. The portable mobile money device of claim 8, wherein said external SIM card is used to establish a network data communication connection.

10. The portable mobile money device of claim 8, wherein said printer is configured to print a transaction receipt for said mobile money transaction.

11. A method for managing Mobile Money transactions comprising:
(a) providing a mobile money device having at least a CPU, a GSM engine, antenna, display, keypad/touchpad, printer and SIM reader configured to accept insertion of an external SIM card;
(b) inserting an external SIM card into said SIM reader;
(c) reading said external SIM card;
(d) validating said external SIM card has a SIM Tool Kit application;
(e) registering said external SIM card on a network;
(f) using said network connection to transmit data to and from said mobile money device;
(g) displaying a SIM Tool Kit application menu on said display;
(h) creating a transaction specific memory cache;
(i) choosing at least one option from said menu using said keypad/touchpad and recording said choose in said transaction specific memory cache;
(j) allowing the user to insert data via the keypad or touchpad if requested by the STK and recording the data in the transaction specific memory cache;
(k) sending data regarding said chosen menu option via said network connection;
(l) receiving a response regarding said data via said network;
(m) displaying said response on said display and recording said response in said transaction specific memory cache; and
(n) printing a transaction receipt based on data stored, in said transaction specific memory cache.

12. The method of claim 11, wherein said sending data to the network is accomplished using said GSM engine via one of USSD, SMS and mobile data.

13. The method of claim 11, wherein said printing a transaction receipt includes displaying receipt printing options that include at least the following options:
(a) client only;
(b) operator only; and
(c) client and operator.

14. The method of claim 11, wherein said transaction receipt includes all data of steps in the SIM Tool Kit menu that were performed during the mobile money transaction.

15. The method of claim 11, wherein said SIM Tool Kit application menu options include at least one of crediting a mobile money account and deducting from a mobile money account.
